(19) United States
(12) Patent Application Publication
(10) Pub. No.: US 2011/0318500 A1
(43) Pub. Date: Dec. 29, 2011

(54) POWDER COATING APPARATUS AND POWDER COATING METHOD (AS AMENDED)

(76) Inventor: Hirokazu Kawaoka, Aichi (JP)

(21) Appl. No.: 13/202,341

(22) PCT Filed: Feb. 26, 2010
(86) PCT No.: PCT/JP2010/053039

§ 371 Date: Aug. 19, 2011

(30) Foreign Application Priority Data
Mar. 12, 2009 (JP) 2009059839

(51) Int. Cl. B05D 1/06; B05B 5/053

(52) U.S. Cl. 427/475; 118/638

(57) ABSTRACT

Powder coating apparatus is equipped with a shutter for opening and closing the space between an object to be coated and a screen electrode. First, a powder is supplied onto the screen electrode from a hopper while the shutter is closed. Next, a brush is slidingly rubbed against the surface of a powder layer while the shutter is closed. The powder is thereby uniformed on the screen electrode without being transferred to the object. Subsequently, a high voltage is applied between the screen electrode and a transfer electrode to form a static electric field, and the shutter is opened. Then, the brush is slidingly rubbed against the powder layer again, and the powder on the screen electrode is coated on the object.

### CROSS-REFERENCE TO RELATED APPLICATIONS

This is a national phase application based on the PCT International Patent Application No. PCT/JP2010/053039 filed on Feb. 26, 2010, the entire contents of which are incorporated herein by reference.

### TECHNICAL FIELD

The present invention relates to a powder coating apparatus and a powder coating method for applying powder to an object. More particularly, the present invention relates to a powder coating apparatus and a powder coating method for transferring powder onto an object by use of electrostatic force.

### BACKGROUND ART

Heretofore there is widely known an electrostatic coating technique of transferring powder onto an object by use of electrostatic force. In recent years, this electrostatic coating technique attracts attention in various fields as well as for coating of an object. For instance, this electrostatic coating technique is also under review for manufacture of electrodes for nonaqueous type secondary batteries.

The powder coating method utilizing the electrostatic coating technique is disclosed in for example Patent Literature 1 in which powder is supplied to a sponge-like roller surface and then the roller is rotated while being pressed against a screen electrode, thereby supplying the powder onto an object through holes of the screen electrode. Further, Patent literature 2 discloses a method of supplying powder by dispersing the powder onto a screen electrode and vibrating the screen electrode up and down, thereby supplying the powder onto an object through holes of the screen electrode.

### CITATION LIST

### Patent Literature

Patent Literature 1: JP 64(1989)-9955 B2

Patent Literature 2: JP 61(1986)-116578 A

### SUMMARY OF INVENTION

However, the above conventional techniques have the following disadvantages. Specifically, the thickness of a film (a coating layer) formed on the object varies. For instance, in the case where the powder is applied from a roller as disclosed in Patent Literature 1, the uniformity of the thickness of the coating layer formed on the object is almost equal to the uniformity of the amount of powder to be pushed out of the screen electrode by the roller. This uniformity of the powder amount depends on the uniformity of the powder amount supplied from the hopper to fall down onto the roller. However, it is very difficult to supply a fixed amount of powder from the hopper. Further, a part of the powder supplied onto the roller is absorbed into the sponge-like roller and another part of the powder bounces back from a curved surface of the roller. It is therefore very difficult to control the powder amount to be pushed out of the roller.

On the other hand, in the case where no roller is used as in Patent Literature 2, nonuniformity of thickness of the coating layer will not occur. However, in the case where the powder is dispersed from the hopper as in Patent Literature 2, the uniformity of the thickness of the coating layer is almost equal to the uniformity of the amount of powder dispersed onto the screen electrode. This uniformity of the powder amount depends on the uniformity of the amount of powder supplied from the hopper. It is therefore hard to form a coating layer with high accuracy.

The present invention has been made to solve the above problems and has a purpose to provide a powder coating apparatus and a powder coating method capable of forming a coating film or layer with high thickness uniformity on an object.

### SOLUTION TO PROBLEM

To achieve the above purpose, one aspect of the invention provides a powder coating apparatus for applying powder to an object, the apparatus comprising: a screen electrode formed with a number of holes; supply means for supplying the powder onto the screen electrode; a transfer electrode placed to face an opposite surface of the screen electrode from a surface to be supplied with the powder from the supply means, the transfer electrode being configured to form an electrostatic field between the screen electrode and the transfer electrode when high voltage is applied to the transfer electrode; smoothing means located above the surface of the screen electrode to which the powder is supplied from the supply means, the smoothing means being movable in parallel to the screen electrode to smooth a powder layer formed on the screen electrode; and a shutter placed between the screen electrode and the transfer electrode to open and close between the object and the screen electrode placed between the electrodes, the apparatus being adapted to, while the shutter is in a closed state, supply the powder onto the screen electrode from the supply means and move the smoothing means in parallel to the screen electrode and on the powder layer formed on the screen electrode, and the apparatus being adapted to, while the shutter is in an open state, apply the powder supplied on the screen electrode to the object placed between the screen electrode and the transfer electrode.

The above powder apparatus includes the shutter to open and close the space between the object and the screen electrode. While the shutter is closed, the powder is supplied onto the screen electrode. While the shutter is closed, furthermore, the smoothing means slides and rubs against the powder layer. Thereby, the powder layer on the screen electrode is made uniform over the screen electrode without moving to the object. Thereafter, high voltage is applied between the screen electrode and the transfer electrode to form an electrostatic field. Then, the shutter is opened and the powder on the screen electrode is allowed to move to the object through the electrostatic field.

In the above powder coating apparatus, specifically, while the shutter is in a closed state once, the powder is supplied and the smoothing means is moved in parallel to and on the powder layer formed on the screen electrode, thereby uniformizing the powder layer. When the thickness of the powder layer becomes uniform, the shutter is opened, allowing the powder to be applied to the object. In other words, the powder is applied after the thickness of the powder layer becomes uniform. This can achieve high uniformity of thickness of the coating film formed on the object.

The above powder coating apparatus may further comprise a protective wall placed on the surface of the screen electrode to which the powder is to be supplied from the supply means, the protective wall surrounding a region to which the powder is to be supplied from the supply means.

Specifically, since the surface of the screen electrode on which the powder layer is to be formed is surrounded, the powder is prevented from scattering to the outside of the apparatus.

Furthermore, the above scattering prevention wall may include at least a portion made of an insulating member, the portion being in contact with the screen electrode.

Specifically, the portion contacting with the screen electrode is made of the insulating member and therefore leakage of electricity can be prevented.

In the above powder coating apparatus, preferably, the shutter in the closed state is placed in contact with the screen electrode. Such shutter closes the holes of the screen electrode and can contribute to a reduction in the amount of powder that leaks from the screen electrode to the shutter while the smoothing means smoothes against the powder layer.

In the above powder coating apparatus, the shutter in the closed state may be placed in noncontact with the screen electrode.

Specifically, any mechanism for bringing the shutter into contact with the screen electrode is unnecessary. Thus, the apparatus can have a simpler configuration.

In the above case, the shutter may include at least a portion made of an insulating member, the portion being in contact with the screen electrode.

Specifically, the portion which will contact with the screen electrode is made of the insulating member, thereby enabling prevention of leakage of electricity.

In the above powder coating apparatus, while the shutter is in the open state, the smoothing means may be moved in parallel to the screen electrode to apply the powder to the object.

Specifically, it is conceivable to include an additional means for coating the smoothed powder to the object. The smoothing means utilized for smoothing is also used for powder coating. In other words, the smoothing means is used both for smoothing and coating. Thus, the apparatus can have a simpler configuration.

Another aspect of the invention provides a powder coating method of applying powder to an object, the method comprising the steps of: placing the object between a screen electrode formed with a number of holes and a transfer electrode facing the screen electrode, the transfer electrode being configured to form an electrostatic field between the screen electrode and the transfer electrode; closing the shutter between the screen electrode and the object and supplying the powder onto the screen electrode while the shutter is in a closed state; placing smoothing means onto a powder layer formed on the screen electrode after start of supplying the powder while the shutter is in the closed state, and moving the smoothing means in parallel to the screen electrode to slide on and smooth the powder layer; applying high voltage between the screen electrode and the transfer electrode to form the electrostatic field; and applying the powder supplied on the screen electrode to the object through the electrostatic field while the shutter is in an open state.

### ADVANTAGEOUS EFFECTS OF INVENTION

According to the present invention, a powder coating apparatus and a powder coating method can be realized, capable of forming a coating film or layer with high thickness uniformity on an object.

### BRIEF DESCRIPTION OF DRAWINGS

FIG. 1 is a schematic configuration view of a powder coating apparatus (with a shutter closed and a cover opened) of an embodiment;

FIG. 2 is a schematic configuration view of a screen electrode;

FIG. 3 is a cross sectional view of the screen electrode taken along a line A-A in FIG. 2;

FIG. 4 is a schematic configuration view of the powder coating apparatus (with the shutter and the cover closed) of the embodiment;

FIG. 5 is a flowchart showing a powder coating process to be performed by the powder coating apparatus of the embodiment;

FIG. 6 is a schematic configuration view of the powder coating apparatus (with the shutter closed and a brush active) of the embodiment;

FIG. 7 is a schematic configuration view of the powder coating apparatus (with the shutter opened and the brush active) of the embodiment.

### DESCRIPTION OF EMBODIMENTS

A detailed description of a preferred embodiment of the present invention will now be given referring to the accompanying drawings. In the following embodiment, the present invention is applied to a powder coating apparatus for use in manufacturing an electrode plate for a lithium ion battery.

(Configuration of Powder Coating Apparatus)

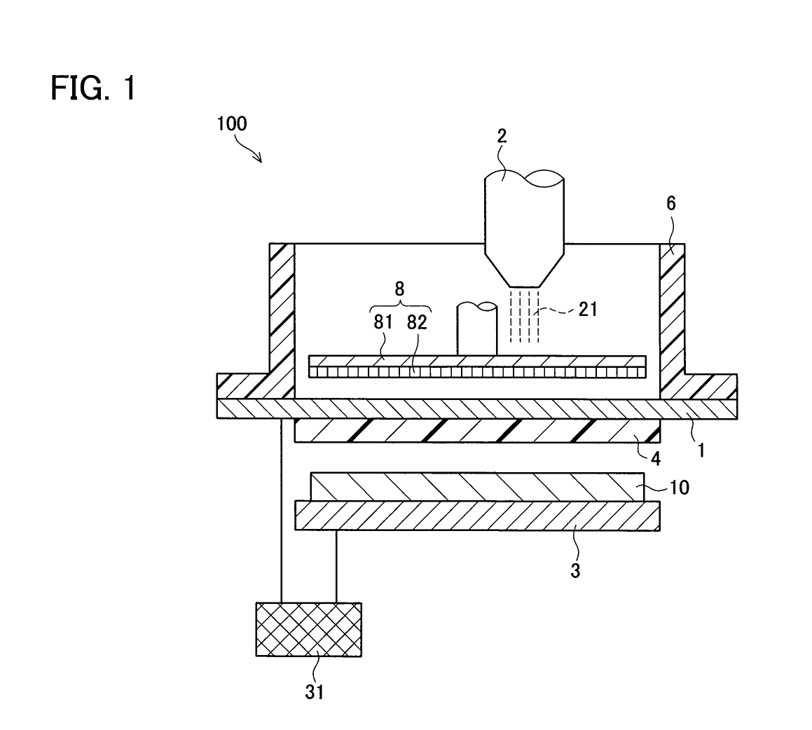

A powder coating apparatus 100 of this embodiment includes a screen electrode 1, a hopper 2, a transfer electrode 3, a shutter 4, a scattering prevention wall 6, and a brush 8, as shown in FIG. 1. An object 10 (an electrode plate for a lithium ion battery, in this embodiment) is placed between the screen electrode 1 and the transfer electrode 3, more concretely, between the shutter 4 in a closed state and the transfer electrode 3. Further, the screen electrode 1 and the transfer electrode 3 are electrically connected to a DC high-voltage power supply 31.

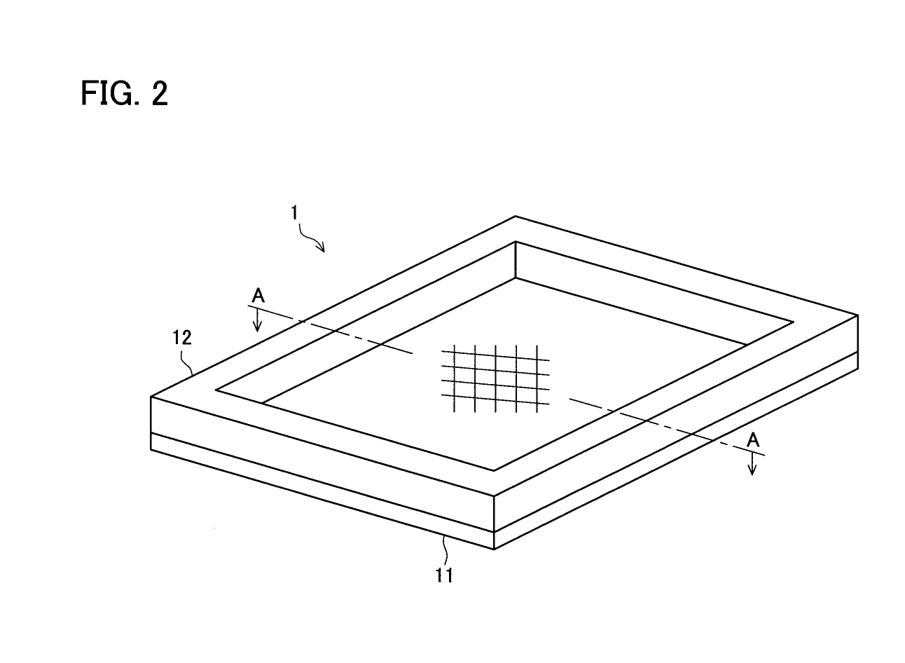

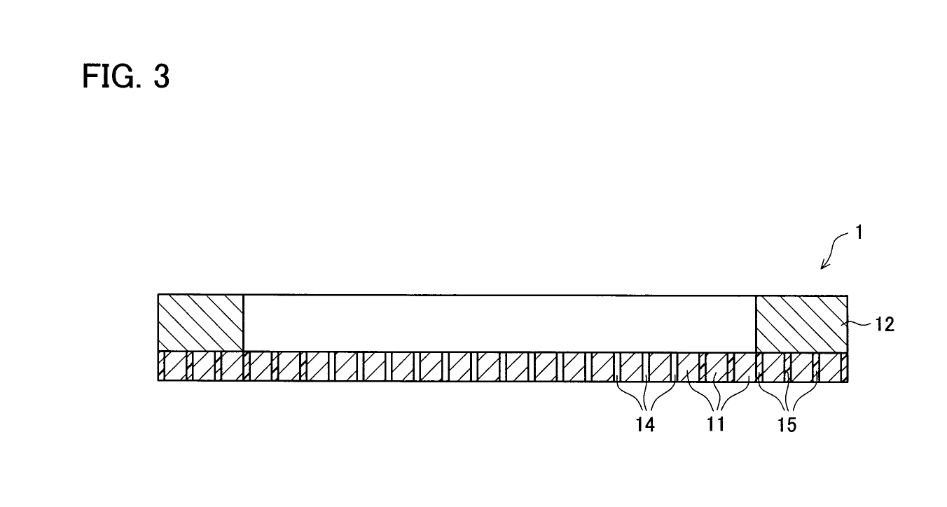

The screen electrode 1 includes a mesh 11 made of stainless steel and a frame 12 made of aluminum (aluminium) as shown in FIG. 2. In this embodiment, each of the mesh 11 and the frame 12 has an outer dimension of 200 mm×200 mm. FIG. 3 is a cross-sectional view taken along a line A-A in FIG. 2. The mesh 11 is formed with about five-hundred holes 14 arranged at equal intervals. In this embodiment, each hole 14 has a maximum width of 25 μm. These holes 14, which are through holes, allow the powder supplied onto one surface of the screen electrode 11 to pass through the screen electrode 11 to the other surface thereof. A part of the holes 14 is filled with insulating resin 15. Specifically, the insulating resin 15 blocks the holes 14 located corresponding to a region other than a region of the object 10 desired to be coated with the powder, i.e., a coating region. Accordingly, the powder can be applied to a desired region.

The hopper 2 is used to supply, onto the screen electrode 1, powder 21 (an electrode material for a lithium ion battery in this embodiment) which will be applied to the object 10. The hopper 2 is placed to be movable in three directions; an up-and-down, a right-and-left direction in FIG. 1, and a depth direction to the drawing sheet of FIG. 1, by a moving mechanism not shown, thereby supplying the powder 21 uniformly within the surface of the screen electrode 1.

The transfer electrode 3 is placed to face an opposite surface of the screen electrode 1 from a surface to which the powder 21 is supplied from the hopper 2. Under application of transfer bias from the DC high-voltage power supply 31, the transfer electrode 3 forms an electrostatic field between the screen electrode 1 and the electrode 3. In this embodiment, a distance between the transfer electrode 3 and the screen electrode 1 is 1.5 mm. Further, the transfer electrode 3 is made of an aluminum sheet and is also used to support the object 10.

The shutter 4 is placed between the screen electrode 1 and the transfer electrode 3 and slidable in a direction (the right-and-left direction in FIG. 1 or the depth direction to FIG. 1) perpendicular to a direction in which the screen electrode 1 and the transfer electrode 3 face each other. In this embodiment, the shutter 4 is made of a stainless sheet with a thickness of 1.0 mm and entirely coated with fluorocarbon resin. While the shutter 4 is in a position between the electrodes 1 and 3, i.e., in a closed state, the shutter 4 restrains movement of the powder 21 to the object 10. While the shutter 4 is in a position not between the electrodes 1 and 3, i.e., in an open state, the powder 21 is allowed to move to the object 10. In the open state, the shutter 4 does not always have to be located completely outside the space between the electrodes 1 and 3. The shutter 4 may be located in at least a position that does not face the coating region of the object 10.

The scattering prevention wall 6 is fixed on the surface of the screen electrode 1 to which the powder 21 will be supplied form the hopper 2. This wall 6 is placed to surround a region of the screen electrode 1 to which the hopper 2 supplies the powder 21. In this embodiment, the scattering prevention wall 6 has a height of 100 mm and fixed to the frame 12 of the screen electrode 1. The scattering prevention wall 6 prevents scattering of the powder 21 to the outside of the apparatus. This wall 6 is made of polypropylene (PP) and thus does not cause leakage of electricity even when it touches other object.

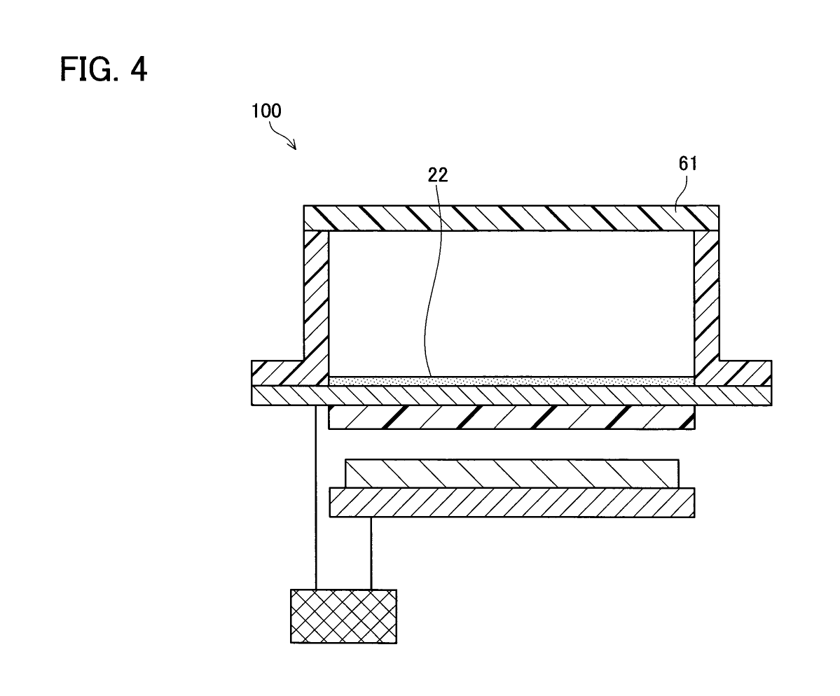

Further, the scattering prevention wall 6 includes a cover 61 on an upper opening as shown in FIG. 4. This cover 61 is used to close the opening. When the cover 61 is to be closed, the hopper 2 is moved outside of the region surrounded by the scattering prevention wall 6. When the cover 61 is closed, a powder layer 22 on the screen electrode 1 is confined within the region surrounded by the scattering prevention wall 6, thereby almost completely preventing the powder from scattering to the outside of the apparatus. Further, foreign matters are also prevented from entering in the region. It is to be noted that the cover 61 is not indispensable.

The brush 8 is a flat planar brush, including a frame member 81 movable in three directions; i.e., an up-and-down direction, a right-and-left direction in FIG. 1, and the depth direction to FIG. 1 and a urethane foam 82 bonded to a lower surface of the frame member 81. The frame member 81 is made of an aluminum sheet of 195 mm×195 mm×5 mm. This frame member 81 is a member for supporting the urethane foam 82 and may be made of any material as long as it has a desired rigidity. The urethane foam 82 is a plastic sponge of 195 mm×195 mm×5 mm. The urethane foam 82 may be made of any member having an insulating property. The brush 8 is placed so that the urethane foam 82 faces the screen electrode 1.

(Configuration of Lithium Ion Battery)

A brief explanation is given to the configuration of a lithium ion battery which is a nonaqueous secondary battery. A power generating element of the lithium ion battery includes a negative electrode consisting of a metal foil and a negative active material coated on both surfaces of the foil and a positive electrode consisting of a metal foil and a positive active material coated on both surfaces of the foil, the electrodes being placed to face each other with a separator interposed therebetween. For coating the active materials which are powder to the metal foils for electrodes, the powder coating apparatus 100 of this embodiment is used.

In this embodiment, to be concretely, an aluminum foil with a thickness of 15 μm is used for the metal foil for a positive electrode plate and lithium cobalt oxide (LiCoO2) having a particle diameter of 2 μm to 15 μm and a mean particle diameter of 5 μm is used for the positive electrode active material. Further, a copper foil with a thickness of 15 μm is used for the metal foil for a negative electrode plate and graphite carbon having a particle diameter of 5 μm to 20 μm and a mean particle diameter of 8 μm is used for the negative electrode active material. A polytetrafluoroethylene (PTFE) powder of a concentration of 5 weight percent is used for a binder. It is to be noted that the above materials used for the positive electrode plate, the powder active material layer, the negative electrode plate, the negative active material layer, and the binder are mere examples and may be appropriately selected from commonly used materials for batteries.

(Sequence of Powder Coating)

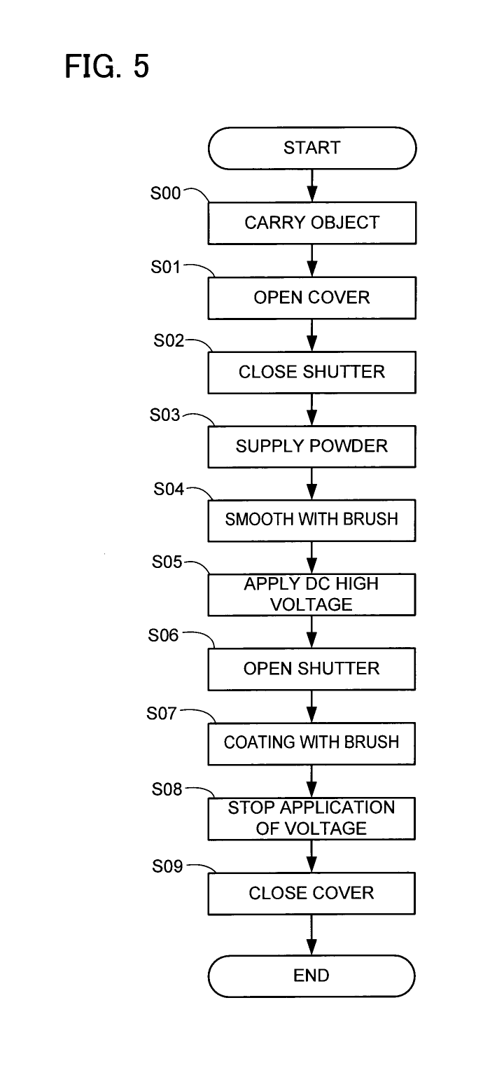

The sequence of operation of the powder coating apparatus 100 is explained below referring to a flowchart in FIG. 5. It is assumed that, at the start, no voltage is applied between the screen electrode 1 and the transfer electrode 3 and the cover 61 is in a closed position.

Firstly, the object 10 (an aluminum foil for the positive electrode plate or a copper foil for the negative electrode plate) is carried onto the transfer electrode 3 (S00). Carrying of the object 10 in S00 is not limited to the timing just after the start but may be conducted before the shutter 4 is opened in S06 mentioned later.

Secondly, the cover 61 is moved away from the scattering prevention wall 6 (S01). Thereby, the region surrounded by the scattering prevention wall 6 is open, so that the hopper 2 and the brush 8 are moved into the relevant region. In the case where the cover 61 is in an open position from the beginning, this step is skipped.

The shutter 4 is moved to between the screen electrode 1 and the object 10 and set in the closed state (S02). In the closed state, the shutter 4 is in contact with the screen electrode 1, closing the holes 14 of the screen electrode 1.

Successively, the hopper 2 is moved so that an outlet thereof comes into the region surrounded by the scattering prevention wall 6 and to a position at a height of 50 mm from the screen electrode 1. While the hopper 2 is being moved horizontally (in the right-and-left or depth direction in FIG. 1), the powder 21 (lithium cobalt oxide for the positive electrode plate or graphite carbon for the negative electrode plate) is supplied to the entire screen electrode 1 (S03). In S03, the powder is supplied until the powder layer 22 is formed with a thickness of about 10 mm on the screen electrode 1.

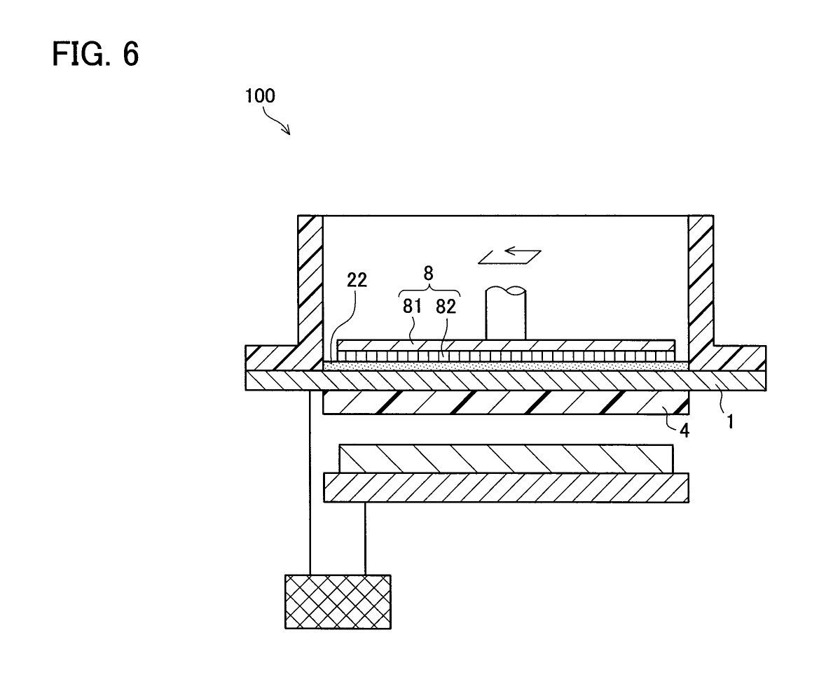

The hopper 2 is then moved out of the region surrounded by the scattering prevention wall 6. The brush 8 is moved into the region surrounded by the scattering prevention wall 6 so that the urethane foam 82 comes into contact with the powder layer 22. And, as shown in FIG. 6, the brush 8 is moved horizontally (in the right and left of depth direction in FIG. 6) (S04), that is, the brush 8 is moved in parallel to the screen electrode 1. During this movement of the brush 8, the urethane foam 82 slides and rubs against the powder layer 22, thereby smoothing the surface of the powder layer 22. This smoothing of the brush 8 is continued for one minute to uniformize the thickness of the powder layer 22. It is to be noted that, during smoothing of the brush 8, the upper surface side (the powder layer 22 side) of the screen electrode 1 is covered by the scattering prevention wall 6. This prevents scattering of the powder to the outside of the apparatus. On the other hand, the lower surface side (the object 10 side) of the screen electrode 1 is in contact with the shutter 4 and hence the powder does not leak from the screen electrode 1.

Specifically, in the case where the two-dimensional center of the screen electrode 1 is defined as (X, Y)=(0, 0), the brush 8 is moved so that the center of the brush 8 comes to a position defined as (+2 mm, +2 mm). Furthermore, the brush 8 is moved to a height at which a distance between the screen electrode 1 and the frame member 81 is 15 mm, that is, to a height at which the urethane foam 82 contacts with the powder layer 22. At that height, the brush 8 is moved around at a speed of 4 sec/cycle so that the center of the brush 8 goes round to the positions defined as (+2 mm, −2 mm), (−2 mm, −2 mm), (−2 mm, +2 mm), and (+2 mm, +2 mm) in this order. This circulating movement is continuously performed for one minute.

After the thickness of the powder layer 22 is made uniform, high voltage is applied between the screen electrode 1 and the transfer electrode 3 from the DC high-voltage power supply 31 (S05). In this embodiment, a DC voltage of 3 kV is supplied. Accordingly, an electrostatic field is formed between the screen electrode 1 and the transfer electrode 3 while the object 10 and the shutter 4 are interposed therebetween.

While a strong electric field is being formed between the screen electrode 1 and the transfer electrode 3, the shutter 4 is moved out from between the screen electrode 1 and the object 10 and placed in the open state (S06).

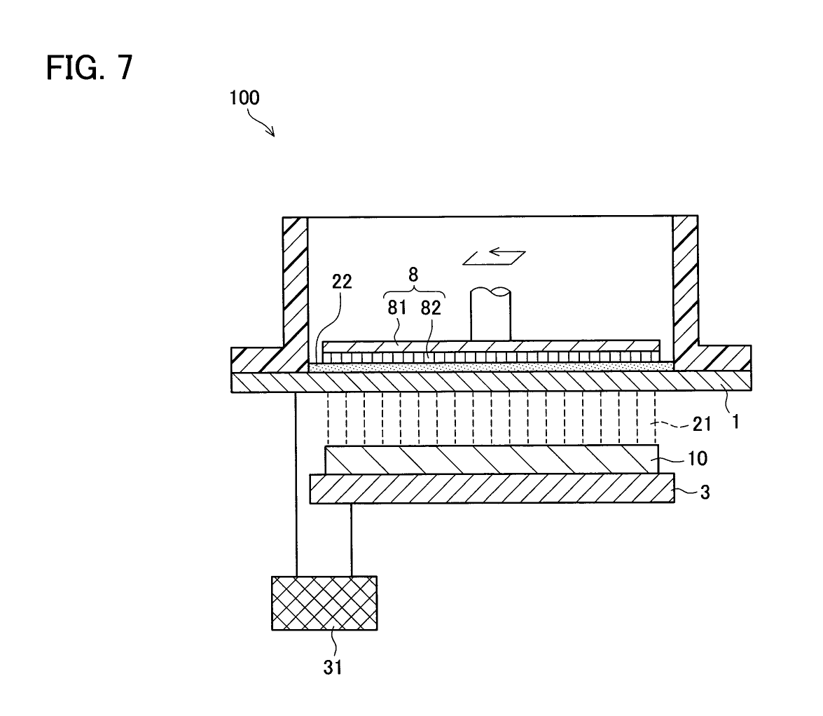

After the shutter 4 is open, the brush 8 is driven again to move slightly downward from the position in S04, thereby increasing the pressure on the powder layer 22, as shown in FIG. 7, and move around with the urethane foam 82 being pressed against the powder layer 22 (S07). This causes the powder 21 on the screen electrode 1 to pass through the holes 14 and fall onto the region in which the electrostatic field is formed. The powder 21 is then charged in passing through the holes 14. The powder 21 is applied onto the object 10 by the electrostatic force. At that time, the thickness of the powder layer 22 on the screen electrode 1 is uniform and therefore the powder 21 is applied uniformly over the object 10.

To be more concrete, the brush 8 is moved downward to a position at a distance of 10 mm between the screen electrode 1 and the frame member 81. Thereby, the urethane foam 82 of the brush 8 is pressed against the powder layer 22. At that height, the brush 8 is driven to move in a similar way to the above. If the pressure of the brush 8 placed at the height in S04 to the powder layer 22 is also sufficient in S07, the brush 8 does not need to be moved down.

After completion of supply of the powder 21, the sliding and rubbing of the brush 8 is stopped and the application of voltage is stopped (S08). Thereafter, the cover 61 is moved to the closed position on the scattering prevention wall 6 (S09), the object 10 is taken out of the powder coating apparatus 100, and the powder is fixed by a fixing device not shown. Consequently, the powder coating is completed.

In this embodiment, while the shutter 4 is in the closed state, the shutter 4 is held in contact with the screen electrode 1. The shutter 4 may be placed to face the screen electrode 1 in non-contact relation. This configuration does not need a mechanism for bringing the shutter 4 into contact with the screen electrode 1 (e.g., a mechanism for moving the shutter 4 up and down) and thus can achieve a simpler apparatus. On the other hand, in the case where the shutter 4 is placed in contact with the screen electrode 1, it is possible to reduce the amount of powder that falls onto the shutter 4 during smoothing of the powder layer 22 (S04). This can reduce waste of powder.

The concrete values presented in this embodiment, i.e., the amount of movement, circulating speed, smoothing time, voltage, the amount of supply of powder, a porous configuration of the screen electrode 1, and others are mere examples and not limited to the above mentioned. In other words, those values and configurations are appropriately selected according to the coating amount and the kind of the powder 21.

The powder coating apparatus 100 in this embodiment explained in detail above includes the shutter 4 to open and close the space between the object 10 and the screen electrode 1. While the shutter 4 is in the closed state, the powder 21 is supplied onto the screen electrode 1. Further, the brush 8 is caused to slide on and rub against the powder layer 2 while the shutter 4 is in the closed state. Therefore, the powder 21 is smoothed on the screen electrode 1 without moving to the object 10. A high voltage is then applied between the screen electrode 1 and the transfer electrode 3, thus forming an electrostatic field. After that, the shutter 4 is brought to the open state and the brush 8 is driven again to slide on and rub against the powder layer 22, thereby causing the powder on the screen electrode 1 to be applied over the object 10. In the powder coating apparatus 100, specifically, the powder is supplied while the shutter 4 is in the closed state once, the powder layer 22 on the screen electrode 1 is smoothed by sliding and rubbing, and then the shutter 4 is opened after the thickness of the powder layer 22 is made uniform, thus the powder 21 is applied to the object 10. That is, after the thickness of the powder layer 22 is made uniform, the powder 21 is applied to the object 10. Therefore, the thickness of a coating layer formed on the object 10 is expected to provide high uniformity.

Especially, an electrode (an object) of the nonaqueous type secondary battery as typified by the lithium ion battery is demanded for the thickness uniformity of the coating layer with an accuracy of 10 μm or less per 1 square centimeter. It can be expected that the powder coating apparatus 100 of this embodiment can meet such high accuracy demand.

The above embodiment merely shows examples without any limitations to the present invention. The present invention may be embodied in other specific forms without departing from the essential characteristics thereof. For instance, in the above embodiment, the present invention is applied to the process of manufacturing electrodes for lithium ion batteries. As an alternative, the present invention may be applied to a technique of manufacturing nonaqueous type secondary batteries other than the lithium ion battery. Further, the present invention may also be applied to, not only the manufacturing technique for the nonaqueous type secondary batteries, but alto a coating technique and a film-forming or deposition technique. The object may include products in general, electronic components, printed boards, and glass boards.

The above embodiment uses the rectangular urethane foam 82 as the smoothing means which slides and rubs against the powder layer 22. Instead thereof, a non-foam material may be used. The shape of the smoothing means may be roller-like and made of a frame member in which brush bristles are implanted.

In the above embodiment, to prevent a short circuit, the urethane foam 82, the shutter 4, and the scattering prevention wall 6 are all made of insulating materials. As an alternative, only parts of them may be made of the insulating materials. Specifically, all the components do not necessarily need to be made of the insulating members as long as a contact portion or a joining portion with the screen electrode 1 is made of the insulating members.

In the above embodiment, the brush 8 functions to smooth in S04 and also coat in S07. These functions may be carried out by separate mechanisms. To be concrete, the coating means may be configured to push out powder by a vibrating mechanism, a squeegee, and others. However, the brush 8 usable for both smoothing and coating can make the apparatus structure simpler.

In the above embodiment, the brush 8 is operated while the cover 61 is in the open position. However, the brush 8 may be configured to be movable even while the cover 61 is in the closed position. In this case, the brush 8 is operated to perform smoothing of the powder layer 22 and coating of the powder 21 while the cover 61 is in the closed position. In this case, the powder layer 22 is completely enclosed and thus the powder 21 can be more prevented from scattering to the outside of the apparatus.

### REFERENCE SIGNS LIST

1 Screen electrode

14 Hole

2 Hopper (Supply means)

21 Powder

22 Powder layer

3 Transfer electrode

31 DC high-voltage power supply

4 Shutter

6 Scattering prevention wall

8 Brush (Smoothing means)

81 Frame member

82 Urethane foam

10 Object

100 Powder coating apparatus

1. A powder coating apparatus for applying powder to an object, the apparatus comprising:
a screen electrode formed with a number of holes;
supply means for supplying the powder onto the screen electrode;
a transfer electrode placed to face an opposite surface of the screen electrode from a surface to be supplied with the powder from the supply means, the transfer electrode being configured to form an electrostatic field between the screen electrode and the transfer electrode when high voltage is applied to the transfer electrode;
smoothing means located above the surface of the screen electrode to which the powder is supplied from the supply means, the smoothing means being movable in parallel to the screen electrode to smooth a powder layer formed on the screen electrode; and
a shutter placed between the screen electrode and the transfer electrode to open and close between the object and the screen electrode placed between the electrodes,
the apparatus being adapted to, while the shutter is in a closed state, supply the powder onto the screen electrode from the supply means and move the smoothing means in parallel to the screen electrode and on the powder layer formed on the screen electrode, and
the apparatus being adapted to, while the shutter is in an open state, apply the powder supplied on the screen electrode to the object placed between the screen electrode and the transfer electrode.

2. The powder coating apparatus according to claim 1, further comprising:
a protective wall placed on the surface of the screen electrode to which the powder is to be supplied from the supply means, the protective wall surrounding a region to which the powder is to be supplied from the supply means.

3. The powder coating apparatus according to claim 2, wherein the protective wall includes at least a portion made of an insulating member, the portion being in contact with the screen electrode.

4. The powder coating apparatus according to claim 1, wherein the shutter in the closed state is placed in contact with the screen electrode.

5. The powder coating apparatus according to claim 4, wherein the shutter includes at least a portion made of an insulating member, the portion being in contact with the screen electrode.

6. The powder coating apparatus according to claim 1, wherein while the shutter is in the open state, the smoothing means is moved in parallel to the screen electrode to apply the powder to the object.

7. The powder coating apparatus according to claim 1, wherein the object is an electrode plate for a nonaqueous type secondary battery.

8. A powder coating method of applying powder to an object, the method comprising the steps of:
placing the object between a screen electrode formed with a number of holes and a transfer electrode facing the screen electrode, the transfer electrode being configured to form an electrostatic field between the screen electrode and the transfer electrode;
closing the shutter between the screen electrode and the object and supplying the powder onto the screen electrode while the shutter is in a closed state;
placing smoothing means onto a powder layer formed on the screen electrode after start of supplying the powder while the shutter is in the closed state, and moving the smoothing means in parallel to the screen electrode to slide on and smooth the powder layer;
applying high voltage between the screen electrode and the transfer electrode to form the electrostatic field; and
applying the powder supplied on the screen electrode to the object through the electrostatic field while the shutter is in an open state.

9. The powder coating method according to claim 8, wherein while the shutter is in the closed state, the shutter and the screen electrode are in contact relation.

10. The powder coating method according to claim 8, wherein while the shutter is in the closed state, the shutter and the screen electrode are in noncontact relation.

11. The powder coating method according to claim 8, wherein
the powder applying step includes applying the powder to the object by moving the smoothing means in parallel to the screen electrode.

12. The powder coating method according to claim 8, wherein the object is an electrode plate for a nonaqueous type secondary battery.
